(19) United States
(12) Patent Application Publication
(10) Pub. No.: US 2009/0185665 A1
(43) Pub. Date: Jul. 23, 2009

(54) Method and server/module for service configurations test

(75) Inventor: Can Feng Chen, Beijing (CN)

Correspondence Address: HARRINGTON & SMITH, PC, 4 RESEARCH DRIVE, Suite 202, SHELTON, CT, 06484-6212, US

(73) Assignee: Nokia Corporation

(21) Appl. No.: 12/009,539

(22) Filed: Jan. 17, 2008

(51) Int. Cl. H04M 1/24

(52) U.S. Cl. 379/29.01

(57) ABSTRACT

The present application discloses a server or corresponding module that includes a communication unit configured to receive, from a first terminal, a request including at least an identification of a second terminal. The server further includes a processor unit configured to control, based on the request, the communication unit. The communication unit thus controlled connects to a value-added service module such as a ring-back server, and such connection emulates a connection from the second terminal to the first terminal. The communication unit receives a value-added service such as a ring-back service from the ring-back server, and delivers information on the received ring-back service to the first terminal. Likewise, a corresponding method and computer program product is disclosed. By virtue thereof, service configuration settings at the value-added service module that are set for the first terminal can be tested by the user of the first terminal without involvement of a second terminal.

### FIELD OF THE INVENTION

The present invention generally relates to a method and a server or module, respectively configured to test for service configurations.

### BACKGROUND OF THE INVENTION

Mobile communication has made considerable progress in recent years. Starting from a traditional circuit switched (CS) approach as e.g. pursued in the Global System of Mobile Communication (GSM), the technological evolution has made its way towards packet switched (PS) systems such as those operating for example on the basis of the Internet Protocol (IP). Examples of such communication systems are the Universal Mobile Telecommunication Standard (UMTS) also referred to as Third Generation (3G) telecommunication system, or a system known as IMS system (IP Multimedia System), or a network operating on the basis of the Session Initiation Protocol SIP. While in former systems, speech or voice was a main aspect of “media” as payload data to be conveyed via the communication system, nowadays all kind of media are focused on as payload, e.g. speech, music (audio), images (still images, i.e. pictures, as well as moving images, i.e. videos), executable program code, text data, and many other types or combinations of media types. “Media” as used in this document is to be understood as not being limited to a specific type of media but is intended to be used in its broadest possible meaning.

With the emerging development of new systems, those systems coexist in parallel and interoperability is one aspect of the development. In particular in case of users (represented by their terminals, e.g. mobile stations MS in GSM or user equipment UE in UMTS and/or IMS that are illustrated/referred to also as “handsets”) that may move and/or roam throughout the communication networks, the users expect seamingless services of high quality to be provided to them, irrespective of the current communication system in which they camp.

A connection from/to a terminal represents a logical association between two endpoints, one of which being the terminal. In a CS domain, the connection relies on a bearer connection (or call) between the endpoints. In a PS domain, the connection relies on a session established between the endpoints. The connection (call or session) comprises signaling and payload (media) delivered, and thus a signaling channel is established as well as a media channel. Each of the channels thus may in principle rely on PS or CS access domain.

It is to be noted that the examples given in conjunction with the present invention are not intended to be limiting in any way. Rather, specific terminology as used in some passages in this document is adopted as an example only to simplify the description of the present invention and to illustrate a particular case to which the present invention may advantageously be applicable. This, however, is not intended to exclude any other field of application for the present invention.

Service in networks are attributed an increasing attention and importance by users. Conventionally, a ring-back tone represents an audible ringing tone or ring-back signal. That is, the audible ringing that a calling party experiences by hearing on the telephone line after dialing a callee's telephone number, but prior to the call being answered at the callee's receiving end. Such a tone assures to the calling party that a ringing signal is being sent on the called party's (callee's) line, although the ring-back tone may not be synchronized with the actual ringing signal.

Conventionally, however, such a ring-back tone was provided centrally by the respective network operator and thus uniformly to all users using the network. Nowadays, with the increasing focus on customizable services provided to individual users, among such services, also a ring-back services exist. This means that a callee (user) may have subscribed to a ring-back service that enables the callee to have presented a customized, e.g. individual ring-back tone to a caller when the caller calls the callee. Such individual ring-back tone insofar then “replaces” the conventional ring-back signal provided by the network operator to all callers in the network. Such an individual ring-back tone may comprise audio and/or video media, or a preconfigured individual message (e.g. an automatic replying instant message). The term “individual” may be referred to the callee having subscribed to such service, but also to the caller. Namely, a ring-back tone may be provisioned by the callee to differ from caller to caller, e.g. not only dependent on the caller's identity (e.g. address or telephone number within the network) but optionally also dependent on the day, time, terminal capabilities, network subscribed to and/or network associated to, etc.

When the user has set-up such a ring-back tone service (audio/video), paid to download one ring-back tone (e.g. new pop music), or set an automatic replying instant message (e.g. “in meeting, back soon . . . ”), he is eager to have a preview. In other words, he wants to know whether the service will work correctly when a caller among his contacts for which he set up that service calls/connects him, especially when some service is specially made for some very important, VIP, person (e.g. the callee's boss, or his wife, etc.).

This problem can be referred to as a problem for service parameter testing, and actual service testing. However, in current mobile communication systems, when the user dials his own phone number, the mobile service switching centre, MSC, or any other switch of similar functionality, will return a signalling to the extent that informs the user that “line is busy, please try later”. The failure reason for this is that the user cannot place a call or connect to his own terminal using his own terminal.

Let's say the user who wants to test his service configuration is user A. Currently, the popular way for user A to perform server parameter testing is to have use a phone number/SIM card from another person, say user B. User A can use user B's phone to dial or send an instant message to his own (user A's) phone number. This is inconvenient when the user cannot find another (fixed) phone or mobile phone at hand from a user B. Also, in case user A provisioned services for plural callers B, C, D, etc., such scenario would require him to repeat the above procedure as may times as he has set up individual ring-back tones for callers placing a call or connecting towards his terminal. Such number does increase with the number of individual ring-back-tones for callers, that may depend on the caller's identity (e.g. address or telephone number within the network) but optionally also on the day, time, terminal capabilities, network subscribed to and/or network associated to, etc.

Thus, there is a problem how to test how other devices do hear/see a ring-back service that is set-up for them by a first device (user A) without actually requesting/disturbing the other devices (i.e. users) to call/contact the first device to hear/see a ring-back service. Although the above scenarios were given for the example of a user configured ring-back service, similar problems exist with other similar types of such user configured value-added services. A ring-back service is thus merely used as an example for any value-added services.

### SUMMARY OF THE INVENTION

It is hence an object of the present invention to provide for corresponding improvement in the hitherto known scenarios.

According to exemplary embodiments of the present invention, this object is for example achieved by the following exemplary aspects of a method, and server as well as module, and computer program product exemplarily embodying a respective aspect of the invention, as outlined herein below, together with respective individual further refinements of the above exemplary aspects:

A method aspect comprises receiving, from a first terminal, a request including at least an identification of a second terminal, connecting to a value-added service module, the connecting emulating a connection from the second terminal to the first terminal, receiving a value-added service from the value-added service module, and delivering information on the received value-added service to the first terminal.

According to individual sub-aspects of the method aspect:
connecting to the value-added service module comprises setting-up a call;
the value-added service module is a server;
the method further comprises storing the received value-added service;
the delivering of information on the value-added service further comprises forwarding, to the first terminal, a message including information on the received value-added service;
the delivering of information on the value-added service further comprises forwarding, to the first terminal, a content of the received value-added service;
the delivering of information on the value-added service further comprises establishing a connection with the first terminal and sending a content of the stored value-added service to the first terminal;
establishing the connection comprising setting up a call with the terminal;
establishing the connection comprising setting up a message session with the terminal;
the request received further comprises an identification of a test type;
the identification of the second terminal comprises at least an address of the second terminal;
the method further comprises connecting to the value-added service module based on at least one of a type of the second terminal, a status of the second terminal, a network to which the second terminal is associated, a location of the second terminal within the network, connection history information;

A server aspect comprises a communication unit configured to receive, from a first terminal, a request including at least an identification of a second terminal, a processor unit configured to control, based on the request, the communication unit to connect to a value-added service module, the connecting emulating a connection from the second terminal to the first terminal, to receive, a value-added service from the value-added service module, and to deliver information on the received value-added service to the first terminal.

According to individual sub-aspects of the server aspect:
the connection to the value-added service module is a call;
the value-added service module is a server;
the server further comprises a memory unit configured to store the received value-added service under control of the processor unit;
the communication unit configured to deliver information on the value-added service is further configured to forward, to the first terminal, a message including information on the received value-added service;
the communication unit configured to deliver information on the value-added service is further configured to forward, to the first terminal, a content of the received value-added service;
the communication unit configured to deliver information on the value-added service is further configured to establish a connection with the first terminal and to send a content of the stored value-added service to the first terminal;
the connection establishment comprises a call, set-up with the terminal;
the connection establishment comprises a message session, set-up with the terminal;
the request received further comprises an identification of a test type;
the identification of the second terminal comprises at least an address of the second terminal;
the communication unit is further configured to connect to the value-added service module based on at least one of a type of the second terminal, a status of the second terminal, a network to which the second terminal is associated, a location of the second terminal within the network, connection history information.

A module aspect comprises a communication unit configured to receive, from a first terminal, a request including at least an identification of a second terminal, a processor unit configured to control, based on the request, the communication unit to connect to a value-added service module, the connecting emulating a connection from the second terminal to the first terminal, to receive a value-added service from the value-added service server, and
to deliver information on the received value-added service to the first terminal.

According to individual sub-aspects of the module aspect:
the module is a chipcard insertable to a terminal;
the module is a chipcard insertable to a network element.

A computer program product aspect comprises software code portions which, when executed on a processor, comprise performing receiving, from a first terminal, a request including at least an identification of a second terminal, connecting to a value-added service module, the connecting emulating a connection from the second terminal to the first terminal, receiving a value-added service from the value-added service module, and delivering information on the received value-added service to the first terminal.

A server means aspect comprises receiving means for receiving, from a first terminal, a request including at least an identification of a second terminal, connecting means for connecting to a value-added service module, the connecting means for emulating a connection from the second terminal to the first terminal, receiving means for receiving a value-added service from the value-added service module, and delivering means for delivering information on the received value-added service to the first terminal.

Stated in other words, according to at least an exemplary example of the present invention, a scenario is presented for remote self testing of self-provisioned services. In this regard, a test server or corresponding module is provisioned in the network system, which is referred to as mirror-test server/module. The mirror-test server is identified by an address set up for the mirror/test server. The testing as such relies on a “loopback test address” such as a phone number for addressing the mirror-test server. The mirror-test server in turn simulates/emulates a connection such as a call to the callee by e.g. a caller's phone number that is insofar “faking” as the caller whose phone number is used for test-calling does not actually place a call to the callee. Additionally, in connection with at least one exemplary example of the present invention, the other devices' type/features and home network type, current network type and current location as well as connection (call) history information can be taken into account when testing. Note that in the present document, the expression “mirror-test” is used in a similar meaning as “loopback test”. In such a mirror-test, any value-added service configured by a user A to be provided for another user B can thus be tested by user A. In the present specification, a ring-back service or auto-reply instant message service is chosen as a respective example of such value-added services. With regard to the ring-back service, the ring-back service may provide any media as ring-back signal, such as a tone, or audio, or vide, or pictures, or any other combination of media types. In such case, the mirror-test server retrieves the configured ring-back signal (e.g. tone or media) from a ring-back service server/module and insofar acts as a ring-back tone resolver.

Thus, with the present invention being realized, at least some of the following advantages can be achieved, whether individually or in aggregation for a respective particular exemplary embodiment:
A ring-back service can be tested without disturbing other users,
the other devices' type/features and home network type, current network type and current location and call history information can be taken into account when testing
A user who set up such ring-back tone server can check his service provided for specific contact(s) (calling parties) in respective specific situations (calling time/number of call attempts (i.e. connection (call) history), caller location, etc).

The ring-back tone service and its testing would be made available by service providers or network operators and is expected to boost customized services configured by the users themselves and is expected to satisfy end-users' self-service impulse.

### BRIEF DESCRIPTION OF THE DRAWINGS

The invention will be readily understood when read in conjunction with the accompanying drawings, which shows in

FIG. 1 a simplified signaling diagram for a mirror test for ring-back tone according to an embodiment of the invention;

FIG. 2 a simplified signaling diagram for a mirror test for auto-reply instant message according to an embodiment of the invention;

FIG. 3 a simplified signaling diagram for a modification of a mirror test for ring-back tone according to an embodiment of the invention;

FIG. 4 a simplified diagram for explaining exemplary steps performed in connection with the mirror test according to an embodiment of the invention;

FIG. 5 (comprising FIGS. 5A and 5B) shows a signaling diagram illustrating various scenarios of a more detailed implementation according to embodiments of the invention;

FIG. 6 a simplified overview of a network system deploying a mirror test server according to an embodiment of the invention; and

FIG. 7 a block circuit diagram of a mirror-test server module in connection with at least one exemplary embodiment of the invention.

### DESCRIPTION OF EXEMPLARY EMBODIMENTS

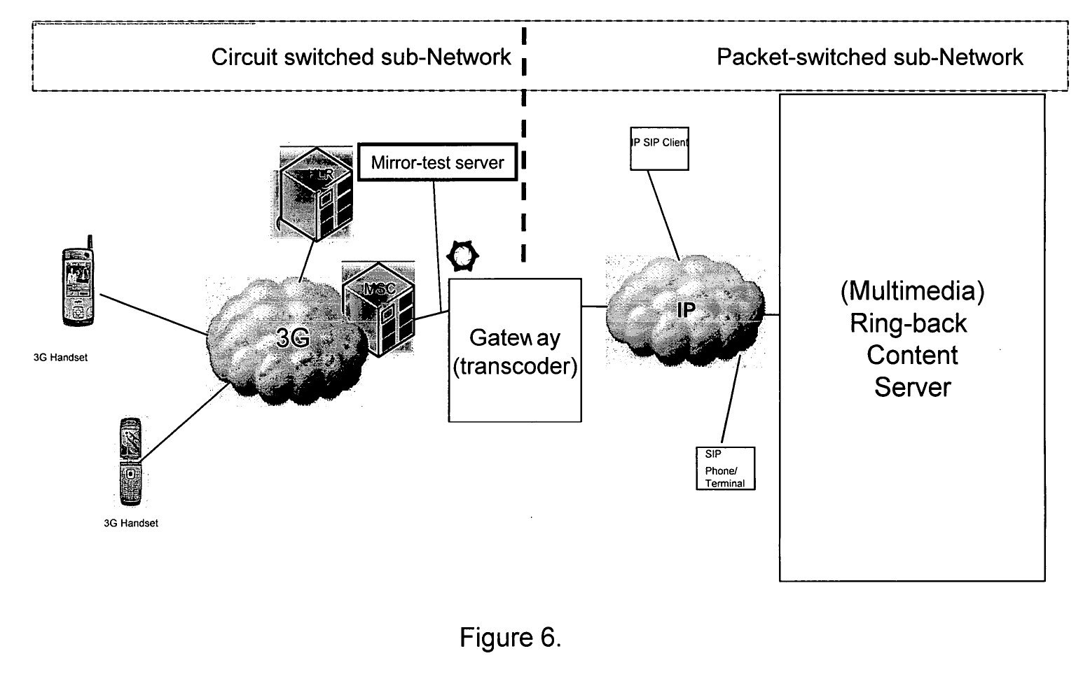

FIG. 6, describing one embodiment of the invention, shows a simplified overview of an exemplary network system deploying a mirror test server. The illustrated network system comprises a circuit network and a packet network, but is not restricted to such a scenario. The circuit and packet networks are interconnected by a gateway providing for transcoding between various communication protocols used in the respective circuit and/or packet network subsystem. The circuit network subsystem comprises, among further non-illustrated entities, a subscriber register HLR and a mobile services switching center MSC. These entities operate via the circuit switched 3G network illustrated as a “cloud” so as to provide services (such as phone calls) to terminals connected thereto. Those terminals represent the respective users thereof and are denoted as 3G handset. However, the fact that handsets are illustrated does not necessitate that the invention is limited to mobile terminals/handsets or users. Generally, the present invention is applicable for any wireless or wired, fixed or portable, terminal type, such as a mobile communication device, a mobile phone, a mobile computer, a laptop/desktop computer, a video/audio player, a digital camera/camcorder, a positioning device (such as a Global Positioning System—GPS device, and a game console, a television, a FM/AM/digital radio, or any combination of the aforementioned. In the packet switched network subsystem, communication relies on the Internet Protocol IP based network represented by a similar “cloud”. Connected thereto are terminals that are denoted as IP SIP client and/or SIP handsets, thus showing before mentioned other types of terminals. Furthermore, a server or module for ring back services is shown. Such a server stores in a memory portion thereof the respective value-added service, e.g. a ring-back service, such as ring-back tones/audio, rink-back videos, ring-back images, ring-back maps, auto-reply instant messages, emails or SMS messages, or any combination of the aforementioned. For example, the message may include any kind of media files additionally to, or instead of, a message text. The ring-back server/module represents a value-added service server/module, as the value-added service is represented by the ring-back services to a caller.

Furthermore, FIG. 6 illustrates a mirror-test server/module involved in the mirror test scenarios according to exemplary embodiments of the invention. As shown in FIG. 6, the mirror-test server is located in the circuit network subsystem, between the MSC and the gateway. However, this is an example only and other locations of the mirror-test server in the network system are possible depending on the network and system configuration.

Also, FIG. 6 illustrates the mirror module in this example implemented as a stand-alone server. However, the mirror-test server may be integrated to any other network entities or even to a terminal. Namely, the mirror-test server may in an exemplary example take the form of a module that is e.g. removably connectable or insertable to a device. The module is for example a chipcard/chipset/circuit board/digital signal processor DSP insertable to a terminal, or the module is a chipcard/chipset/circuit board/digital signal processor DSP insertable to a network element. For example, this “mirror-test” server can be integrated with existing network entities, such as the ring-back server, an IP Multimedia—IM—server, a network gateway, or IN (Intelligent Network) server, or with a mobile services switching MSC entity or subscriber register HLR. Without any change to the communication protocols and network architecture, for example IVR (Interactive Voice Response) can be a good candidate for the user to perform the loopback test, i.e. to place a corresponding request for testing to the mirror-test server. Alternatively, the user may place a user message such as an SMS (Short Message Service) message or USSD (Unstructured Supplementary Service Data) message addressed to the mirror-test server as his request for testing. Nevertheless, the present invention is not limited to any of these scenarios and others may be applicable, as long as the mirror-test server receives an appropriate request.

According to the invention, there is introduced a mirror-test server/module and an associated “loopback test number” (generally an address) for every device user to perform the server parameter/actual service testing. That is, based on the “loopback test number” as the mirror-test server or module's address, each user may place requests for testing to the mirror-test server/module. Each user may receive the same mirror-test server address, if a single mirror-test server is provisioned only. Nevertheless, plural mirror-test servers may be present in the network system. If so, these are identified by different addresses and the address informed to a user may vary from user to user, e.g. dependent on his network operator, the services subscribed to, etc.

The “mirror-test” server/module is used to perform the loopback test responsive to a user's request. The main functions of the server/module include:

1) Understanding the test type requested by the user,

2) Simulating/emulating a caller's phone number,

3) Delivering (e.g. after recording or instantaneously) the (e.g. multimedia) content from another server such as a value-added service server, e.g. represented by a ring-back tone server to the requesting user.

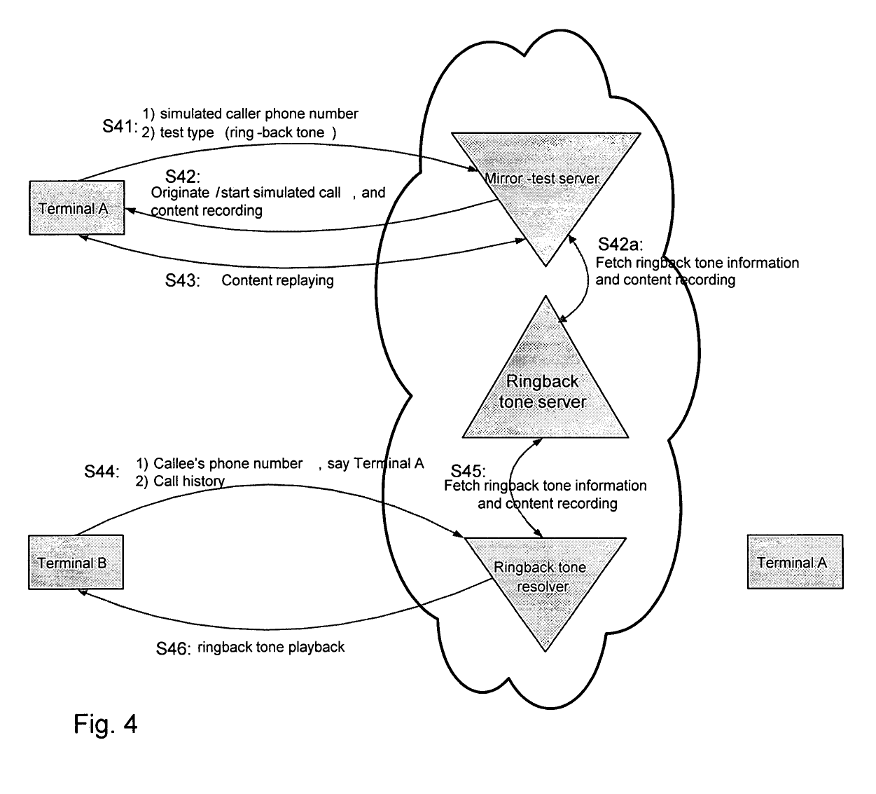

FIG. 4, describing one embodiment of the invention, shows a simplified diagram for explaining such exemplary steps performed in connection with the mirror test.

In the first step S41, the user A connects to the mirror-test server/module by, e.g. dialling the loopback test number or sending a message to the loopback test number/address. The thus addressed mirror-test server will prompt the user to enter the simulated caller's phone number (generally an address) and the test type (e.g. for ring-back tone settings), then optionally prompt the user to break the connection or hang-off, and resolve the request. (The mirror test server is thus acting as a ring-back resolver explained below.)

In the second step S42, the mirror-test server initiates a connection, like a call by dialling the user's phone number or like a session by sending an instant message. The call or the message will be directed to the ring-back tone server (as shown in step S42a) (or an instant message server, generally the value-added service server), the mirror-test server receives (and optionally records or stores) the content or feedback message(ring back tone or automatic replying instant message) delivered by the ring-back tone server (S42a) (or instant message server). In the third step S43, the user is informed that the test is ready, e.g. by a message (SMS, Email, USSD, including the automatic instant reply message) or by a call from the mirror-test server.

In the third step, upon the user re-establishing the connection, like picking up the phone, the (recorded/stored) content will be rendered/re-played to the user by the mirror-test server, which completes the loopback test (mirror-test).

Alternatively, the mirror-test server doesn't record/store the ring-back content but directs it to the user's device (i.e. user doesn't hang-up after the first step).

Thus, the mirror-server acts like a ring-back resolver in an “ordinary” call received from a user B calling a user A, who set up a personalized ring-back tone service. This is illustrated in the lower part of FIG. 4. In step S44, a user/terminal B calls user/terminal A by identifying terminal A's( the callee's) telephone number or terminal address. Terminal B also identifies the call (connection) history such as day, time, or number of call attempt. The call reaches the ring-back tone resolver that resolves, S45, the data in the call and fetches corresponding information/content from a ring-back tone server or module. In step S46, the ring-back tone or message set up by user A for terminal B (optionally under consideration of additional criteria as mentioned above) is rendered/played to the terminal B.

A ring-back content server thus stores ring-back contents, such as tones or audio and/or video or even multimedia files, or automatic replying instant messages, in a memory allocated thereto, e.g. according to the following manner:

| | | |
|---|---|---|
| User | RBT/Auto reply | details |
| A | For user | |
| | B1: | |
| | B1_1 | day/time 1 |
| | B1_2 | day/time 2 |
| | B1_3 | repeated call attempt |
| | B2: | |
| | B2_1 | . . . |
| | . . . | . . . |

Thus, user A has configured ring-back tone services as an example of value-added services for users B1 and B2. The settings comprise, for user B1, three different ring-back tones RBT and/or auto replies: B1_1, B1_2, and B1_3 in the illustrated abbreviated scenario. B_1 is played at day and/or time #1, while B1_2 is used at day/time #2, and e.g. B1_3 is used in case of a repeated call attempt. Various other criteria may be used in such settings, such as terminal type, network type . . . for user B. The respective content e.g. B1_2 is fetched depending on matching criteria such as day/time.

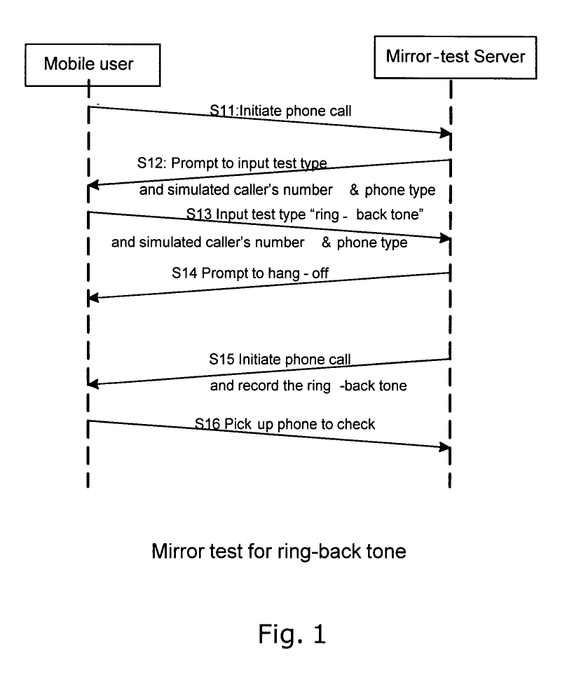

In FIGS. 1 to 3 and 5A, 5B, entities are shown in horizontal arrangement and the signaling exchanged between them as time lapses is illustrated in the vertical direction. A Party is denoted as “mobile” user, but is not limited thereto and fixed users may also be applicable. A party is also exemplified by referring to its terminal such as a handset.

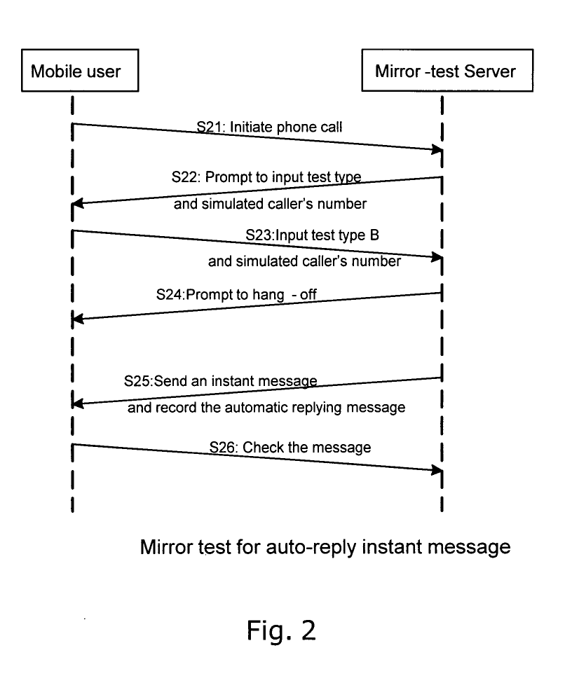

FIG. 1, describing one embodiment of the invention, shows a simplified signaling diagram for a mirror test for ring-back tone according to one exemplary scenario. A (e.g. mobile) user initiates a connection such as a phone call in step S11 to the mirror-test server. The mirror-test server responds in step S12 by prompting the user to input the test type (e.g., ring-back tone), the simulated caller's, i.e. second terminal's phone number (caller B's number) and optionally phone type (e.g. multimedia enabled) or other criteria such as a status of the second terminal, a network to which the second terminal is associated, a location of the second terminal within the network, call history information. In step S13, the user wishing to test the ring-back service he customized returns the requested data (to the extent possible, but at least the test type and the simulated caller's number). In step S14, the user is prompted to hang-off. Then, in step S15, the mirror test server initiates a phone call towards the mobile user (A) and emulates a call from the second terminal to the first terminal. Such a call is routed within the network system to the ring-back tone server (not shown here). That ring-back tone server delivers the ring-back tone to the mirror-test server that records it (S15). In step S16, upon being prompted by the mirror-test server, the mobile user picks up his phone again and calls the mirror-test server to check the content that the mirror-test server received from the ring-back tone server when emulating the call from the second terminal. Checking involves playing the content received, e.g. ring-back tone (audio and/or video) or auto-reply instant message (described in connection with FIG. 2).

FIG. 2, describing one embodiment of the invention, shows a simplified signaling diagram for a mirror test for auto-reply instant message. The signaling of steps S21 to S26 is quite similar to the one shown in FIG. 1 for steps S11 to S16. However, the test type input in FIG. 2 by the user in step S23 indicates a test for an auto-reply instant message (e.g. denoted as type B in FIG. 2) (rather than for a ring-back tone). Further, instead of placing a call, the mirror test server sends an instant message to the value-added service server such as the ring-back tone server and records the automatic reply message received therefrom. In step S26, the user checks that message.

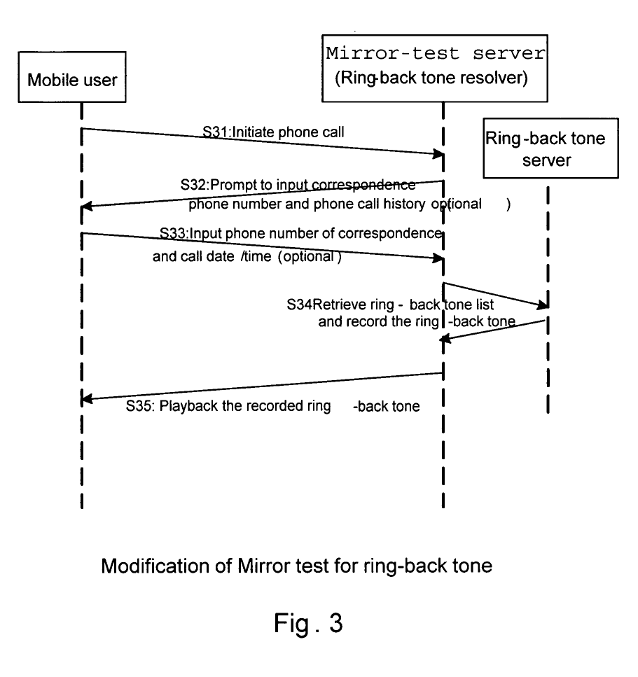

FIG. 3, describing one embodiment of the invention, shows a simplified signaling diagram for a modification of a mirror test for ring-back tone. In this modification, steps S31 to S33 are similar to steps S11 to S13 in FIG. 1. Steps S14 and S16 of FIG. 1 do not have a direct corresponding step in FIG. 3, since the user is not prompted to hang-off but remains connected to the mirror-test server. The mirror test server in FIG. 3 is now referred to as ring-back tone resolver that connects/queries a ring-back tone server or, more generally, value-added services server. In step S34, the resolver/mirror test server retrieves the ring-back tone list for the simulated caller, e.g. B1 in the above listed example, and records the matching ring-back tone, e.g. B1_2, depending on the criteria (e.g. phone call history) input by the user in step S32. Recording can be made at the mirror test server either “permanently” (e.g in connection with the FIG. 1, 2 scenarios) or temporarily as in the present modified scenario (FIG. 3). Namely, the recorded/retrieved ring-back tone is played to the user in step S35 as long as the user does not hang-off.

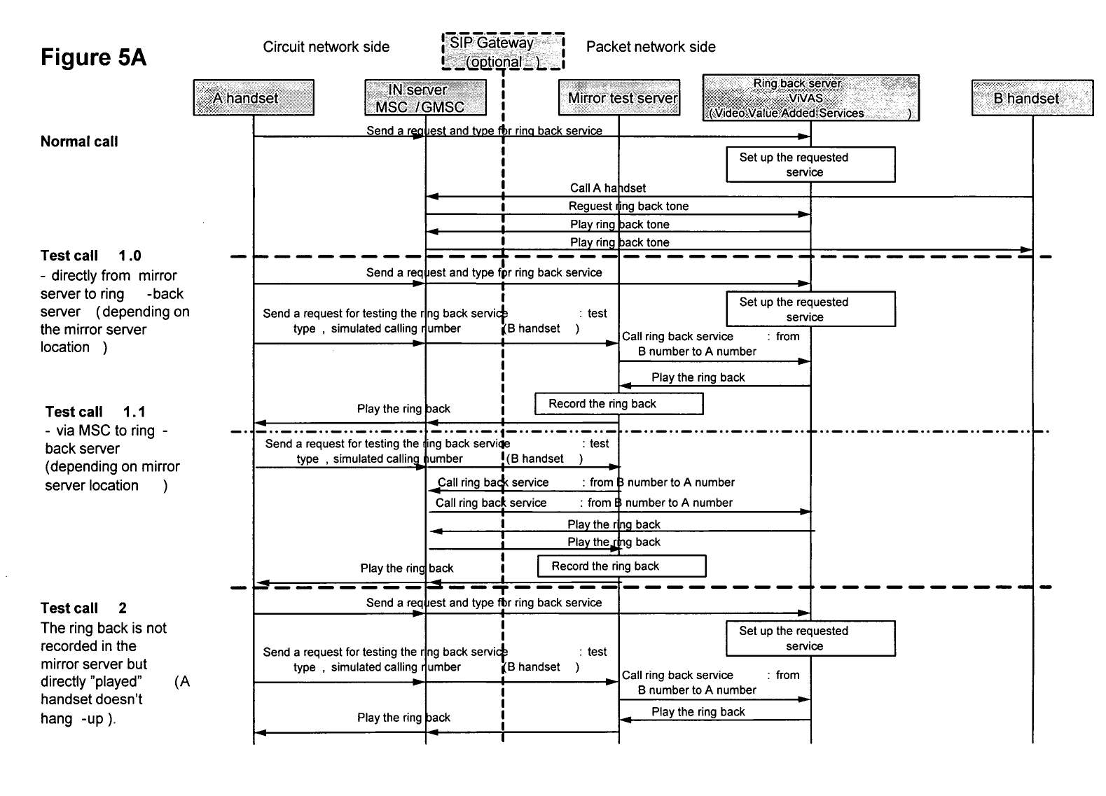

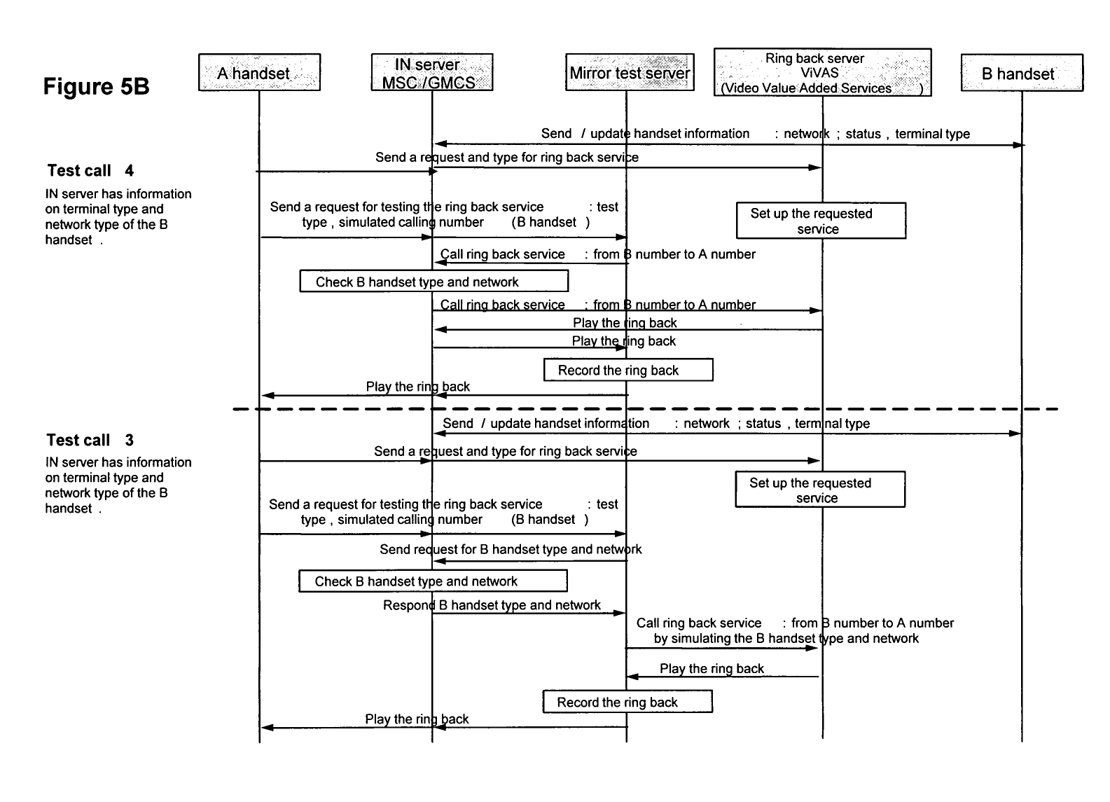

FIG. 5, describing embodiments of the invention, (comprising FIGS. 5A and 5B) shows a signaling diagram illustrating various scenarios of more detailed implementations of further embodiments. FIG. 5 shows various scenarios which are referred to as:
“Normal call”:
this is a normal ring-back use scenario, not involving testing;
   “Test call 1.0”:
This is one exemplary embodiment for the invention, For all scenarios related to embodiments of the invention, it is to be noted that the mirror-test server can be located anywhere in or between the IN server/MSC/GMCS and the ring-back tone server, or in the gateway. The presence of a (SIP based) gateway is optional.
   “Test call 1.1”:
This is another exemplary embodiment in which the test-call is routed differently than in scenario “Test call 1.0”.
   “Test call 2”:
This is another exemplary embodiment where the retrieved ring-back tone is not recorded in the mirror-test server/module but delivered instantaneous to the user A. “Test call 3” and “Test call 4” have additional features in that the ring-back tone service is aware of (“knows”) other user's (B's) terminal type and network as examples of criteria which may e.g. comprise at least one of a type of the second terminal, a status of the second terminal, a network to which the second terminal is associated, a location of the second terminal within the network, connection (e.g. call) history information.

In FIG. 5A and 5B, “A handset” denotes a user A's terminal. User A represents a callee who wants to test his service settings for the event of being called by a caller B's terminal denoted as “B handset”. Any communication and message exchange (signalling and payload) between the terminals is accomplished via the network system which the terminals access. The network system comprises, among others not shown, an Intelligent Network, IN, server, an MSC and Gateway MSC, GMSC. Optionally, a gateway, e.g. SIP based gateway and/or Voice over IP, VoIP, gateway, is provided to interconnect circuit switched and packet switched communication sub-systems. A mirror-test server as an exemplary instance of the present invention is represented as a single entity. However, the mirror-test server can be a functional module that is connected/inserted to one of the other network entities or even to a terminal. Further, a ring-back server/module providing ring-back services to a user is provided. Since ring-back tones are no longer restricted to tones as such but may involve (multi-)media such as audio and or video to be played as a ring-back signal, the ring-back server is represented as a video value-added services server.

In the “normal call” scenario, user A sends a request for and type of a ring-back service via the network system to the ring-back server. At the ring-back server, the requested service is set up for user A. This may involve setting up a memory having contents as e.g. briefly discussed with reference to the table herein above. Once set up, if a caller B calls the callee A via the network system, the IN server/MSC/GMSC requests a ring-back tone from the ring-back server. The ring-back server plays the ring-back tone to the IN server/MSC/GMSC, which in turn plays the ring-back tone to the caller. The played ring-back tone was configured by the callee A at the ring-back server to be played to caller B when B calls A. The ring-back tone played to B may differ based on certain optional criteria as explained above.

In the following scenarios, such a service is assumed to be set up for user A at the ring-back server and the corresponding steps from the normal call scenario are therefore not described once more. Rather, the description of those other scenarios starts with the self-test request of user A for the provisioned services.

(Note that the Test call 1.0 scenario is similar to the example described with reference to FIG. 1. The test call 2 scenario is similar to the example described with reference to FIG. 3.)

In Scenario 1.0, user A sends a request for testing the ring-back service to the mirror-test server. He may already include in his request the test type (e.g. ring-back or auto reply (see FIG. 2)) and the simulated calling number (of the caller B). Alternatively, (see FIG. 1) the mirror-test server may prompt user A in response to his request to do so. Once the mirror-test server knows these indications, it emulates a connection from B to A, and thus calls user A as if it were user B, and calls a (previously configured) ring-back service from the ring-back server. The ring-back server plays the ring-back content such as a specified tone, or music, or video, etc. to the mirror-test server. That played-back ring-back content is stored at the mirror-test server for being played/rendered to the user A initiating the test. This playing-back of the ring-back content to user A can be user controlled, e.g. when he has hung-off his phone after the request, playback is performed after he picks up his phone again, or can be mirror-test server controlled, e.g. immediately after the ring-back content was received and stored at the mirror-test server, the mirror-test server plays the content to user A's terminal or handset.

Note that in test call 1.0, the mirror-test server exchanged requests and responses with the ring-back server directly.

Test call 1.1 differs in this regard from scenario 1.0 because of the location of the mirror-test server. Namely, in test call 1.1, the mirror-test server calls the ring-back service via the IN server/MSC/GMSC, which forward this to the ring-back server. Likewise, the ring-back content is first delivered from the ring-back server via the IN server/MSC/GMSC to the mirror-test server. The remaining steps in scenarios 1.0 and 1.1 are identical.

In test call scenario 2, the ring-back is not recorded in the mirror-test server but directly “played”, i.e. delivered to user A's terminal. Thus, after the initial test request, the user did not hang-up his handset but the connection to the mirror-test server was maintained. In other aspects, scenario 2 is similar to scenario 1.0. Note that also scenario 2 can be modified as a further scenario 2.1., similar as scenario 1.1., concerning the signalling between mirror-test server and the ring-back server then involving the IN server/MSC/GMSC as an intermediate node. Such a scenario 2.1 is, however, not illustrated in FIG. 5.

Test calls scenarios 4 and 3 are shown in FIG. 5B. In both of them, the IN server has information on the terminal type, network type etc. of the caller's terminal, i.e. user B's terminal. In scenario 3 and 4, therefore, the terminal of user B sends and/or updates handset information related to terminal B to the IN server. Sending/updating can be done initially upon power on of terminal B as regards the network and/or terminal type. The status can be updated always when the status changes, or confirmed in regular intervals or at predetermined times. The confirming is optionally also applicable to the network and terminal type information.

The callee, i.e. user A, sets up a ring-back service as described in relation to other scenarios at the ring-back server. Of course, the ring-back content (signal) applicable for a certain user B can then (in addition or alternatively to the above illustrated table of possible settings) for example be configured as follows:

| | | |
|---|---|---|
| User | RBT/Auto reply | details |
| A | For user | |
| | B1: | |
| | B1_4 | video enabled |
| | B1_5 | polyphone audio enabled |
| | B1_6 | others |
| | B2: | |
| | B2_1 | . . . |

The details may refer to the network properties as well as to the terminal properties. Namely, in case the network does not support multimedia (video) transmission as a ring-back content (signal), it is not important whether the terminal is supporting such application. On the other hand, if the network is enabled for that purpose, it is important that also the terminal supports such application.

Similar as in other scenarios, the user A requests a test for his configured ring-back service in the manner as described above.

Responsive thereto, in scenario 4, the mirror-test server initiates a connection, e.g. a call for the emulated caller's number B to the calle's number A, i.e. the number of the user, for a ring-back service. This call is routed via the IN server, where a check for the terminal type and network of the emulated caller B is performed. Thereafter, the call is forwarded further to the ring-back server and based on the checked network/terminal type of emulated/simulated caller B, a corresponding content entry for the ring-back signal to be played is retrieved (e.g. B1_5 in the example above for polyphonic enabled network/terminal). The ring-back server then plays the retrieved ring-back signal (content) to the IN server, which forwards it to the mirror-test server, where it is recorded before playing it to the user A's terminal so as to complete the test initiated by user A. Of course, scenario 4 can be modified in that no recording is performed at the mirror-test server, then similar to scenario 2 in that regard.

Test call scenario 3 is similar to scenario 4 described above with the following exception.

In scenario 3, when the mirror-test server/module receives the request for testing the ring-back services, it first sends a request to obtain information on the type and network of terminal B to the IN server. At the IN server, a check for the terminal type and network of the emulated caller B is performed. Thereafter, the IN server responds the type of terminal and network of caller B to the mirror-test server. Only then and based on the checked network/terminal type of emulated caller B, the mirror-test server initiates a connection such as a call for the emulated caller's number B to the calle's number A, i.e. the number of the user, for a ring-back service to the ring-back server so that a corresponding content entry for the ring-back signal to be played is retrieved. The remaining steps of scenario 3 are similar to those of scenario 4. Also, modifications of scenario 4 explained above are available for scenario 3 (i.e. the ring-back content need not be stored at the mirror-test server but can be played directly to the callee A's terminal). Also, in scenario 3, the connection (call) from the mirror-test server to the ring-back server as well as the ring-back signal (content) from the ring-back server to the mirror-test server can be routed via the IN server/MSC/GMSC, similar as in scenario 1.1 described above.

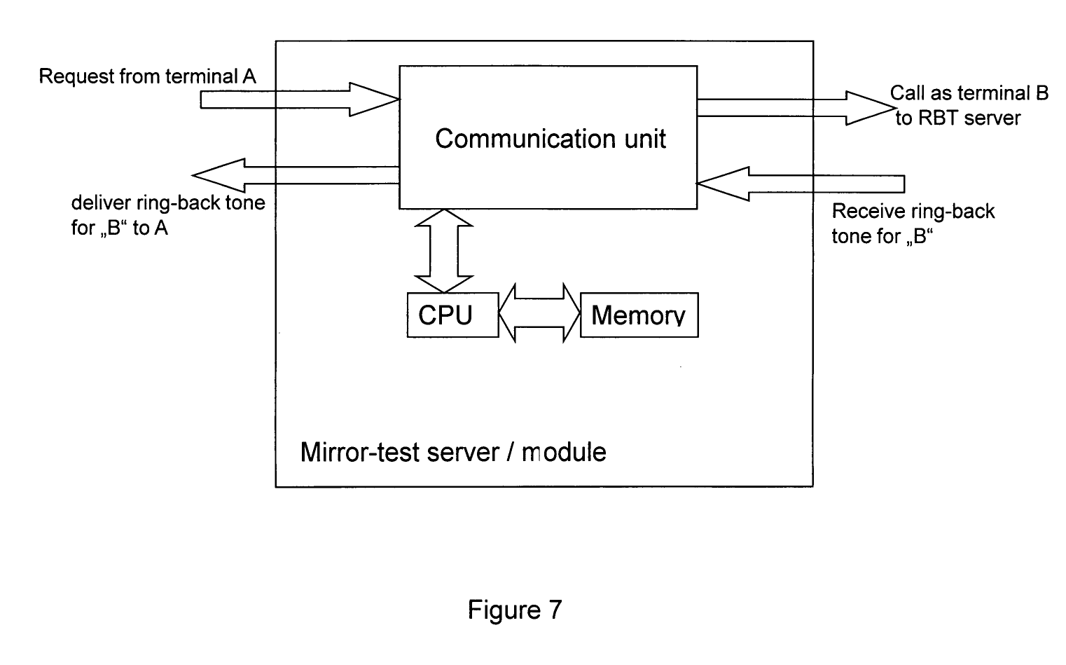

FIG. 7, describing one embodiment of the invention, shows a block circuit diagram of a mirror-test server/module. Hereinbefore, the exemplary embodiments of the method implemented as well as the signaling involved in this regard between network entities were described. In the following, details of the internal structure of the mirror-test server/module involved in the present invention will be described.

FIG. 7 shows an example constitution of such a mirror-test server/module, whether as a stand-alone server entity or as a module connectable to another device such as a network entity (e.g. server, including a value-added service server such as a ring-back tone server) or a terminal.

The mirror-test server comprises a communication unit configured to receive, from a first terminal, a request including at least an identification of a second terminal. Further, the mirror-test server comprises a processor unit configured to control, based on the request, the communication unit.

Based on the control exerted by the processor unit, and dependent on the scenario in which it is deployed, the communication unit connects to (e.g. calls) a value-added service server/module, e.g. a ring-back server/module. Such connecting (calling) emulates a connection (call) from the second terminal to the first terminal. Further, the communication unit receives a value-added service from the value-added service server, and delivers information on the received value-added service to the first terminal. The server further comprises a memory unit configured to optionally store/record the received value-added service under control of the processor unit. Once stored, the value added service received such as a content of the ring-back service, can then be delivered at a different time to the first terminal. The communication unit is configured to deliver information on the value-added service in a manner so as to forward, to the first terminal, a message including information on the received value-added service, or to forward, to the first terminal, a content of the received value-added service. According to a particular aspect the communication unit is further configured to establish a connection with the first terminal and to send a content of the stored value-added service to the first terminal. Such a connection establishment may comprise a call, set-up with the terminal, or may comprise a message session, set-up with the terminal.

The request received further comprises an identification of a test type, while the identification of the second terminal comprises at least an address of the second terminal. Under certain aspects, the communication unit is further configured to connect to (e.g. call) the value-added server based on at least one of a type of the second terminal, a status of the second terminal, a network to which the second terminal is associated, a location of the second terminal within the network, connection (call) history information. Dependent on at least one of those criteria, the mirror-test server retrieves the correspondingly pre-set ring-back signal as an example of a provisioned value-added service content. For the purpose of the present invention as described herein above, it should be noted that
an access technology may be any technology by means of which a user equipment can access an access network (e.g. via a base station or generally an access node). Any present or future technology, such as WLAN (Wireless Local Access Network), WiMAX (Worldwide Interoperability for Microwave Access), BlueTooth, Infrared, and the like may be used; although the above technologies are mostly wireless access technologies, e.g. in different radio spectra, access technology in the sense of the present invention may also imply wirebound technologies, e.g. IP based access technologies like cable networks or fixed lines but also circuits switched access technologies; access technologies may be distinguishable in at least two categories or access domains such as packet switched and circuit switched, but the existence of more than two access domains does not impede the invention being applied thereto,
an access network may be any device, unit or means by which a station, entity or other user equipment may connect to and/or utilize services offered by the access network; such services include, among others, data and/or (audio-) visual communication, data download etc.;
a user equipment may be any device, unit or means by which a system user may experience services from an access network such as a mobile phone, personal digital assistant PDA, or computer;
method steps likely to be implemented as software code portions and being run using a processor at a network element or terminal, are software code independent and can be specified using any known or future developed programming language as long as the functionality defined by the method steps is preserved;
generally, any method step is suitable to be implemented as software or by hardware without changing the idea of the invention in terms of the functionality implemented;
method steps and/or devices, units or means likely to be implemented as hardware components at a terminal or network element, or any module(s) thereof, are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components; in addition, any method steps and/or devices, units or means likely to be implemented as software components may for example be based on any security architecture capable e.g. of authentication, authorization, keying and/or traffic protection;
devices, units or means can be implemented as individual devices, units or means, but this does not exclude that they are implemented in a distributed fashion throughout the system, as long as the functionality of the device, unit or means is preserved.

Although the present invention has been described herein before with reference to particular embodiments thereof, the present invention is not limited thereto and various modification can be made thereto.

1. A method, comprising
receiving, from a first terminal, a request including at least an identification of a second terminal,
connecting to a value-added service module, the connecting emulating a connection from the second terminal to the first terminal,
receiving a value-added service from the value-added service module, and
delivering information on the received value-added service to the first terminal.

2. The method according to claim 1, wherein connecting to the value-added service module comprises setting-up a call.

3. The method according to claim 1, wherein the value-added service module is a server.

4. The method according to claim 1, further comprising:
storing the received value-added service.

5. The method according to claim 1, wherein the delivering of information on the value-added service further comprises
forwarding, to the first terminal, a message including information on the received value-added service.

6. The method according to claim 1, wherein the delivering of information on the value-added service further comprises
forwarding, to the first terminal, a content of the received value-added service.

7. The method according to claim 4, wherein the delivering of information on the value-added service further comprises
establishing a connection with the first terminal and sending a content of the stored value-added service to the first terminal.

8. The method according to claim 7, wherein establishing the connection comprising setting up a call with the terminal.

9. The method according to claim 7, wherein establishing the connection comprising setting up a message session with the terminal.

10. The method according to claim 1, wherein the request received further comprises an identification of a test type.

11. The method according to claim 1, wherein the identification of the second terminal comprises at least an address of the second terminal.

12. The method according to claim 1, further comprising connecting to the value-added service module based on at least one of a type of the second terminal, a status of the second terminal, a network to which the second terminal is associated, a location of the second terminal within the network, connection history information.

13. A server, comprising
a communication unit configured to receive, from a first terminal, a request including at least an identification of a second terminal,
a processor unit configured to control, based on the request, the communication unit
to connect to a value-added service module, the connecting emulating a connection from the second terminal to the first terminal,
to receive, a value-added service from the value-added service module, and
to deliver information on the received value-added service to the first terminal.

14. The server according to claim 13, wherein the connection to the value-added service module is a call.

15. The server according to claim 13, wherein the value-added service module is a server.

16. The server according to claim 13, further comprising:
a memory unit configured to store the received value-added service under control of the processor unit.

17. The server according to claim 13, wherein the communication unit configured to deliver information on the value-added service is further configured to forward, to the first terminal, a message including information on the received value-added service.

18. The server according to claim 13, wherein the communication unit configured to deliver information on the value-added service is further configured to
forward, to the first terminal, a content of the received value-added service.

19. The server according to claim 16, wherein the communication unit configured to deliver information on the value-added service is further configured to establish a connection with the first terminal and to send a content of the stored value-added service to the first terminal.

20. The server according to claim 19, wherein the connection establishment comprises a call, set-up with the terminal.

21. The server according to claim 19, wherein the connection establishment comprises a message session, set-up with the terminal.

22. The server according to claim 13, wherein the request received further comprises an identification of a test type.

23. The server according to claim 13, wherein the identification of the second terminal comprises at least an address of the second terminal.

24. The server according to claim 13, wherein the communication unit is further configured to connect to the value-added service module based on at least one of a type of the second terminal, a status of the second terminal, a network to which the second terminal is associated, a location of the second terminal within the network, connection history information.

25. A module, comprising:
a communication unit configured to receive, from a first terminal, a request including at least an identification of a second terminal,
a processor unit configured to control, based on the request, the communication unit
to connect to a value-added service module, the connecting emulating a connection from the second terminal to the first terminal,
to receive a value-added service from the value-added service server, and
to deliver information on the received value-added service to the first terminal.

26. The module according to claim 25, wherein the module is a chipcard insertable to a terminal.

27. The module according to claim 25, wherein the module is a chipcard insertable to a network element.

28. A computer program product, comprising software code portions which, when executed on a processor, comprise performing
receiving, from a first terminal, a request including at least an identification of a second terminal,
connecting to a value-added service module, the connecting emulating a connection from the second terminal to the first terminal,
receiving a value-added service from the value-added service module, and
delivering information on the received value-added service to the first terminal.

29. A server means, comprising
receiving means for receiving, from a first terminal, a request including at least an identification of a second terminal,
connecting means for connecting to a value-added service module, the connecting means for emulating a connection from the second terminal to the first terminal,
receiving means for receiving a value-added service from the value-added service module, and
delivering means for delivering information on the received value-added service to the first terminal.
